(19) United States
(12) Patent Application Publication
(10) Pub. No.: US 2021/0089018 A1
(43) Pub. Date: Mar. 25, 2021

(54) METHOD FOR CONTROLLING A MOTOR VEHICLE REMOTELY

(71) Applicant: Robert Bosch GmbH, Stuttgart (DE)

(72) Inventors: Stefan Nordbruch, Kornwestheim (DE); Rolf Nicodemus, Bietigheim-Bissingen (DE)

(21) Appl. No.: 17/002,692

(22) Filed: Aug. 25, 2020

(30) Foreign Application Priority Data
Sep. 23, 2019 (DE) 102019214471.3

(51) Int. Cl. G05D 1/00; B60W 60/00; B60W 50/02; B60W 30/00

(52) U.S. Cl. CPC G05D 1/0011; B60W 30/00; B60W 50/0205; B60W 60/0015

(57) ABSTRACT

A method for controlling a motor vehicle remotely, The method includes: determining that a motor vehicle must be assisted by remote control; receiving safety condition signals, which represent at least one safety condition that must be satisfied, so that the motor vehicle may be controlled remotely; checking if the at least one safety condition is satisfied; generating remote control signals for controlling a lateral and/or longitudinal guidance of the motor vehicle remotely, based on a result of the check as to whether the at least one safety condition is satisfied, in order to assist the motor vehicle by remote control; and outputting the remote control signals generated. A device, a computer program and a machine-readable storage medium are also described.

### CROSS REFERENCE

The present application claims the benefit under 35 U.S.C. § 119 of German Patent Application No. DE 102019214471.3 filed on Sep. 23, 2019, which is expressly incorporated herein by reference in its entirety.

### FIELD

The present invention relates to a method for controlling a motor vehicle remotely. In addition, the present invention relates to a device, a computer program and a machine-readable storage medium.

### BACKGROUND INFORMATION

German Patent Application No. DE 10 2016 213 961 A1 describes a design for controlling a motor vehicle remotely within a parking lot.

German Patent Application No. DE 10 2017 213 204 A1 describes a method and a system for controlling a vehicle remotely.

German Patent Application No. DE 10 2018 107 756 A1 describes systems for outputting a warning signal of a vehicle, in order to warn entities situated in the vicinity.

PCT Application No. WO 2019/028464 A1 describes a vehicle traveling autonomously.

### SUMMARY

An object of the present invention is to provide efficient controlling of a motor vehicle remotely in an efficient manner, in order to assist the motor vehicle remotely in an efficient manner.

This object may be achieved with the aid of example embodiments of the present invention. Advantageous refinements of the present invention are described herein.

According to one aspect of the present invention, a method for controlling a motor vehicle remotely is provided. In an example embodiment of the present invention, the method includes the following steps:

Determining that a motor vehicle must be assisted by remote control;

receiving safety condition signals, which represent at least one safety condition that must be satisfied, so that the motor vehicle may be controlled remotely;

checking if the at least one safety condition is satisfied; generating remote control signals for controlling a lateral and/or longitudinal guidance of the motor vehicle remotely, based on a result of the check as to whether the at least one safety condition is satisfied, in order to assist the motor vehicle by remote control;

outputting the remote control signals generated.

According to a second aspect of the present invention, a device is provided, which is configured to execute all of the steps of the example method according to the first aspect.

According to a third aspect of the present invention, a computer program is provided, which includes commands that, in response to the execution of the computer program by a computer, for example, by the device according to the second aspect, cause it to implement an example method according to the first aspect.

According to a fourth aspect of the present invention, a machine-readable storage medium is provided, in which the computer program according to the third aspect is stored.

In accordance with an example embodiment of the present, the above-mentioned object may be achieved by assisting the motor vehicle, using remote control; prior to the remote control of a lateral and/or longitudinal guidance of the motor vehicle, it being checked if the at least one safety condition is satisfied. If this is not the case, then, in particular, the generation of remote control signals for controlling the lateral and/or longitudinal guidance of the motor vehicle remotely is refrained from. Preferably, the remote control signals are only generated and outputted, when the at least one safety condition is satisfied.

This may produce, for example, the technical advantage that the remote control signals may be generated efficiently. In particular, this produces the technical advantage that it may be ensured, in an efficient manner, that certain conditions, presently, the safety condition, are satisfied, in order to control the motor vehicle remotely. Consequently, in particular, the technical advantage is produced, that if the safety condition is met, the remote control of the motor vehicle is then safely possible.

This may produce, for example, the technical advantage that the remote control of the motor vehicle may be carried out safely.

Therefore, in particular, the technical advantage, that a way for efficiently controlling a motor vehicle remotely, is provided, which allows the motor vehicle to be assisted by remote control (remotely) in an efficient manner.

In the case, in which the remote control signals are remote control signals for controlling the lateral or the longitudinal guidance of the motor vehicle, one specific embodiment of the present invention provides that in each instance, the other guidance, that is, the longitudinal guidance or the lateral guidance, be either controlled manually by the driver (which may then be referred to, in particular, as assisted driving), or controlled in an at least semiautomated manner, in order to drive the motor vehicle in an at least semiautomated manner.

Assisted driving means, in particular, that a driver of the motor vehicle permanently carries out either the lateral guidance or the longitudinal guidance of the motor vehicle. The other respective driving task (that is, controlling the longitudinal or the lateral guidance of the motor vehicle) is automatically carried out remotely. Therefore, this means that in the case of assisted driving of the motor vehicle, either the lateral or the longitudinal guidance is controlled remotely in an automatic manner.

The wording “at least semiautomated driving” includes one or more of the following cases: semiautomated driving, highly automated driving, fully automated driving.

Semiautomated driving means that in a specific situation (for example: driving on an expressway, driving within a parking lot, passing an object, driving within a traffic lane, which is defined by lane markings) and/or for a certain period of time, longitudinal and lateral guidance of the motor vehicle are controlled remotely in an automatic manner. A driver of the motor vehicle does not have to manually control the longitudinal and lateral guidance of the motor vehicle himself/herself. However, the driver must monitor the automatic, remote control of the longitudinal and lateral guidance continuously, in order to be able to manually intervene, if necessary. The driver must be ready to completely take over the driving of the motor vehicle at any time.

Highly automated driving means that for a certain period of time, in a specific situation (for example: driving on an expressway, driving within a parking lot, passing an object, driving within a traffic lane, which is defined by lane markings), longitudinal and lateral guidance of the motor vehicle are controlled remotely in an automatic manner. A driver of the motor vehicle does not have to manually control the longitudinal and lateral guidance of the motor vehicle himself/herself. The driver does not have to monitor the automatic, remote control of the longitudinal and lateral guidance continuously, in order to be able to intervene manually, as required. If necessary, a take-over request to the driver for assuming the control of the longitudinal and lateral guidance is outputted automatically, in particular, outputted with adequate time to spare. Thus, the driver must be potentially able to take over the control of the longitudinal and lateral guidance. Limits of the automatic, remote control of the lateral and longitudinal guidance are detected automatically. In the case of highly automated driving, it is not possible to bring about a minimum-risk state automatically in every initial situation.

Fully automated driving means that in a specific situation (for example: driving on an expressway, driving within a parking lot, passing an object, driving within a traffic lane, which is defined by lane markings), longitudinal and lateral guidance of the motor vehicle is controlled remotely in an automatic manner. A driver of the motor vehicle does not have to manually control the longitudinal and lateral guidance of the motor vehicle himself/herself. The driver does not have to monitor the automatic, remote control of the longitudinal and lateral guidance, in order to be able to intervene manually, when necessary. Prior to an end of the automatic, remote control of the lateral and longitudinal guidance, a request for the driver to take over the driving task (controlling the lateral and longitudinal guidance of the motor vehicle) is made automatically, in particular, with adequate time to spare. If the driver does not assume the driving task, then a return is made automatically to a minimum-risk state. Limits of the automatic control of the lateral and longitudinal guidance are detected automatically. In all situations, it is possible to return automatically to a minimum-risk system state.

According to one specific example embodiment of the present invention, it is provided that the at least one safety condition is, in each instance, an element selected from the following group of safety conditions: presence of a predetermined safety integrity level (SIL) or automotive safety integrity level (ASIL) of at least the motor vehicle and an infrastructure, in particular, including a communication path and/or communications components, for controlling a motor vehicle remotely (in particular, with regard to the overall systems in the motor vehicle and infrastructure, as well as, in particular, parts, e.g., components, algorithms, interfaces, etc.; presence of a maximum latency time of a communication between the motor vehicle and a remote control device for controlling the motor vehicle remotely on the basis of the remote control signals; presence of a predetermined computer protection level of a device for executing the method steps; presence of predetermined components and/or algorithms and/or communication options, which are used for executing the method steps; presence of redundancy and/or diversity in predetermined components and/or algorithms and/or communication options, which are used for executing the method steps; presence of predetermined availability information, which indicates an availability of predetermined components and/or algorithms and/or communication options; presence of predetermined quality criteria of the predetermined components and/or algorithms and/or communication options; presence of a plan, which includes measures for reducing faults and/or measures in response to failures of predetermined components and/or algorithms and/or communication options and/or measures for incorrect analyses and/or measures in response to incorrect interpretations; presence of one or more fallback scenarios; presence of a predetermined function; presence of a predetermined traffic situation; presence of predetermined weather, maximum possible time for a specific performance or execution of one method step or a plurality of method steps; presence of a test result, that elements or functions, which are used for executing the method, are presently functioning correctly.

A communication path is, for example, a communication path between the device according to the second aspect, and the motor vehicle. A communication path includes, for example, one or more communication channels.

In one specific example embodiment of the present invention, a component, which is used for executing the method according to the first aspect, is an element selected from the following group of components: surround sensor, motor vehicle, infrastructure, remote control device, device according to the second aspect, motor vehicle system, in particular, drive system, clutch system, brake system, driver assistance system, communications interface of the motor vehicle or of the infrastructure, processor, input, output of the device according to the second aspect.

In one specific example embodiment of the present invention, a function, which is used for executing the method according to the first aspect, is an element selected from the following group of functions: remote control function, communication function between the motor vehicle and the infrastructure or the remote control device, evaluation function of surround sensor data of a surround sensor, planning function, in particular, travel planning function, traffic analysis function, emissions analysis function.

The following determines, in particular, a computer protection level: activated firewall and/or valid encryption certificate for encryption of a communication between the motor vehicle and the infrastructure or the remote control device, and/or activated virus program including current virus signatures and/or presence of a protection, in particular, mechanical protection, in particular, anti-intrusion protection, of the computer, in particular, of the device according to the second aspect, or of the remote control device, and/or presence of an option for checking that signals, in particular, remote control signals or surrounding-area signals, have been transmitted correctly, that is, error-free.

An algorithm includes, for example, the computer program according to the third aspect.

Since, in particular, it is checked that redundancy and/or diversity is present in predetermined components and/or algorithms and/or communication options, for example, the technical advantage is provided, that in the case of failure of the corresponding component, for example, a computer, or the corresponding algorithm or the corresponding communication option, nevertheless, safe functioning may be implemented.

In order to ensure that results are correct, according to one specific embodiment, these may be computed several times, for example, and the corresponding results may be compared to each other. For example, it is only determined that the results are correct, if the results agree. If an odd number occurs several times, it may then be determined, for example, that the result corresponding to the highest number of equal results is correct.

For example, remote control signals are only generated, when it is able to be determined that the result is correct.

In one specific example embodiment of the present invention, the remote control signals are only generated, if the at least one safety condition is satisfied.

In one specific example embodiment of the present invention, the check as to whether the at least one safety condition is satisfied, is carried out prior to and/or after and/or during one or more predetermined method steps.

In particular, this produces the technical advantage that it may be ensured, in an efficient manner, that certain conditions, presently, the safety condition, are satisfied, in order to control the motor vehicle remotely prior to and/or after and/or during the execution of the corresponding method steps. Consequently, in particular, the technical advantage is produced, that if the safety condition is met, the remote control of the motor vehicle is then safely possible.

In one specific example embodiment of the present invention, it is provided that after the outputting of the remote control signals, remote control of the motor vehicle is tested on the basis of the outputted remote control signals, in order to detect a fault; in response to the detection of a fault, the remote control being broken off, or emergency remote control signals for controlling the lateral and/or longitudinal guidance of the motor vehicle remotely in an emergency being generated and outputted.

The emergency remote control signals are, for example, such, that in the case of the remote control of the lateral and/or longitudinal guidance of the motor vehicle on the basis of the emergency remote control signals, the motor vehicle is carried over into a safe state, in particular, stopped.

In one specific embodiment of the present invention, it is provided that after the outputting of the remote control signals, remote control of the motor vehicle is checked on the basis of the outputted remote control signals, in order to detect a fault; in response to the detection of a fault, the remote control being interrupted, or internal motor vehicle emergency control signals for controlling the lateral and/or longitudinal guidance of the motor vehicle in an emergency being generated and outputted.

The internal motor vehicle emergency control signals are, for example, such, that in the case of the control of the lateral and/or longitudinal guidance of the motor vehicle on the basis of the internal motor vehicle emergency control signals, the motor vehicle is carried over into a safe state, in particular, stopped.

Thus, internal motor vehicle emergency control signals are emergency control signals, which the motor vehicle generates itself and/or are generated in the motor vehicle.

For example, this may produce the technical advantage that in the event of a breakdown of communication, which corresponds, for example, to an emergency, between the motor vehicle and the device according to the second aspect, that is, a remote control device for controlling the motor vehicle remotely, the motor vehicle may also carry itself over into a safe state.

Explanations, which are made in connection with the remote control signals and/or the internal motor vehicle emergency control signals, apply analogously to the emergency remote control signals, and vice versa.

According to one specific example embodiment of the present invention, surrounding-area signals are received, which represent a surrounding area of the motor vehicle; the remote control signals being generated on the basis of the surrounding area.

This may produce, for example, the technical advantage that the remote control signals may be generated efficiently. In particular, this produces the technical advantage that a surrounding area of the motor vehicle may be taken into account efficiently during the generation of the remote control signals.

According to one specific example embodiment of the present invention, it is checked, on the basis of the surrounding area of the motor vehicle, if a current traffic situation permits remote control of the motor vehicle. In particular, the remote control signals are generated or outputted on the basis of a result of the check as to whether the current traffic situation permits remote control.

For example, remote control of the motor vehicle is refrained from, when the current traffic situation does not permit remote control.

This may produce, for example, the technical advantage that other road users in the surroundings of the motor vehicle are not put at risk or injured.

According to one specific example embodiment of the present invention, one or more method steps up to the steps of generating and outputting the remote control signals are executed in the motor vehicle, and/or one or more method steps are executed outside of the motor vehicle, in particular, in an infrastructure, preferably, in a cloud infrastructure.

This may produce, for example, the technical advantage that the corresponding method steps may be carried out in an efficiently redundant manner. In particular, this may further increase safety in an advantageous manner.

According to one specific example embodiment of the present invention, one or more method steps are documented, in particular, documented in a blockchain.

The technical advantage of this is, for example, that on the basis of the documentation, this may also be analyzed subsequently after the performance or execution of the method. In particular, the documentation in a blockchain has the technical advantage that the documentation is safe from manipulation and falsification.

A blockchain (also block chain) is, in particular, a continuously expandable list of data records, called blocks, which are linked together with the aid of one or more crytographic methods. In this context, each block contains, in particular, a cryptographically secure hash (standard value of deviation) of the preceding block, in particular, a time stamp and, in particular, transactional data.

According to one specific example embodiment of the present invention, outputting the generated remote control signals includes transmitting the remote control signals over a communications network, in particular, over a wireless communications network, to the motor vehicle.

According to one specific example embodiment of the present invention, the method according to the first aspect includes controlling the motor vehicle remotely on the basis of the generated remote control signals.

In one specific example embodiment of the present invention, traffic system control signals for controlling at least one traffic system are generated and outputted on the basis of the remote control signals.

This may produce, for example, the technical advantage that the at least one traffic system may assist the remote control of the motor vehicle in an efficient manner.

In the spirit of the description herein, a traffic system is, for example, one of the following traffic systems: traffic light; electronic sign, including an indicating device; communication system, in particular, a V2I communication system; information system; variable-message traffic sign.

For example, the traffic system control signals are such, that in the case of the control of a traffic light on the basis of the traffic system control signals, it directs traffic around the motor vehicle or stops traffic in the surroundings of the motor vehicle.

According to one specific example embodiment of the present invention, status signals are received, which represent a status of the motor vehicle; as a function of the status, it being determined that the motor vehicle must be assisted by remote control.

In this manner, for example, the technical advantage may be produced, that it may be determined, in an efficient manner, that the motor vehicle must be assisted by remoted control.

For example, the status of the motor vehicle indicates that the motor vehicle has a malfunction. In such a case, it is determined that the motor vehicle must be assisted by remote control.

According to one specific example embodiment of the present invention, it is provided that situation signals be received, which represent a situation in which the motor vehicle finds itself; based on the situation signals, it being determined whether the motor vehicle is in an emergency situation, which the motor vehicle is unable to resolve at least in a semiautomated manner; it being determined that the motor vehicle must be assisted by remote control, if the motor vehicle is in an emergency situation, which the motor vehicle is unable to resolve at least in a semiautomated manner.

In this manner, for example, the technical advantage may be produced, that it may be determined in an efficient manner, that the motor vehicle must be assisted by remoted control.

In one specific example embodiment of the present invention, it is tested if an entity made up of the motor vehicle and infrastructure involved in the method, including communication between the infrastructure and the motor vehicle, is safe, so that the motor vehicle and/or a local and/or a global infrastructure and/or communication between the motor vehicle and the infrastructure are tested accordingly. In particular, the remote control signals are generated on the basis of a result of the testing.

Thus, this means, in particular, that the components, which are used during the execution of the method according to the first aspect, are tested for safety, that is, as to whether these satisfy specific safety conditions, before the intervention in the vehicle operation is carried out, that is, before the motor vehicle is controlled remotely.

Important or dependent criteria include, for example, one or more of the safety conditions described above.

According to one specific example embodiment of the present invention, it is provided that the method according to the first aspect be a computer-implemented method.

According to one specific example embodiment of the present invention, the method according to the first aspect is executed or performed with the aid of the device according to the second aspect.

Device features follow analogously from corresponding method features, and vice versa. Thus, this means that, in particular, technical functions of the device according to the second aspect follow analogously from corresponding instances of technical functionality of the method according to the first aspect, and vice versa.

The wording “at least one” stands, in particular, for “one or more.”

Exemplary embodiments of the present invention are represented in the figures and are explained in greater detail below.

### BRIEF DESCRIPTION OF THE DRAWINGS

FIG. 1 shows a flow chart of an example method for controlling a motor vehicle remotely in accordance with the present invention.

FIG. 2 shows a device in accordance with an example embodiment of the present invention.

FIG. 3 shows a machine-readable storage medium in accordance with an example embodiment of the present invention.

### DETAILED DESCRIPTION OF EXAMPLE EMBODIMENTS

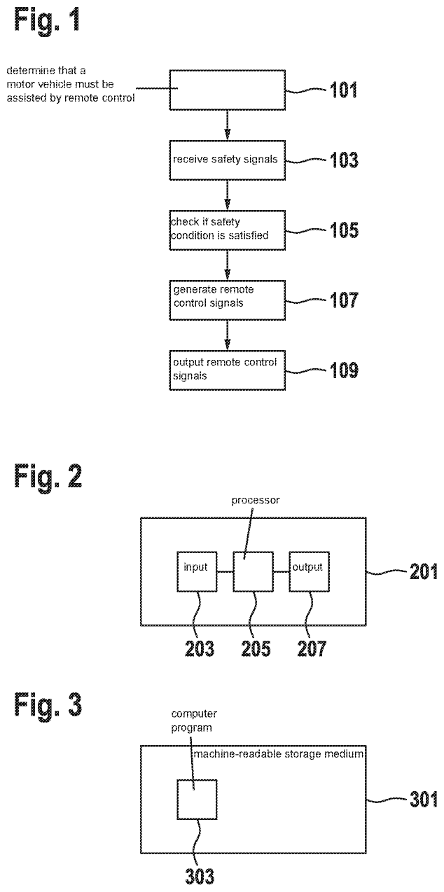

FIG. 1 shows a flow chart of a method for controlling a motor vehicle remotely in accordance with an example embodiment of the present invention.

The example method includes the following steps:

determining 101 that a motor vehicle must be assisted by remote control;

receiving 103 safety condition signals, which represent at least one safety condition that must be satisfied, so that the motor vehicle may be controlled remotely;

checking 105 if the at least one safety condition is satisfied;

generating 107 remote control signals for controlling a lateral and/or longitudinal guidance of the motor vehicle remotely, based on a result of the check as to whether the at least one safety condition is satisfied, in order to assist the motor vehicle by remote control;

outputting 109 the remote control signals generated.

The result of the check indicates, for example, that the at least one safety condition is satisfied. The result of the check indicates, for example, that the at least one safety condition is not satisfied.

In one specific embodiment of the present invention, it is provided that the remote control signals only be generated, if the result of the check indicates that the at least one safety condition is satisfied.

In one specific embodiment of the present invention, it is provided that the generation of remote control signals be refrained from, if the result of the check indicates that the at least one safety condition is not satisfied.

According to one specific embodiment of the present invention, the outputting 109 includes that the generated remote control signals are transmitted over a communications network, in particular, over a wireless communications network, to the motor vehicle.

According to one specific embodiment of the present invention, the method according to the first aspect includes the step of controlling the motor vehicle remotely on the basis of the outputted remote control signals.

FIG. 2 shows a device 201 in accordance with an example embodiment of the present invention.

Device 201 is configured to execute all of the steps of the method according to the first aspect.

Device 201 includes an input, which is configured to receive the safety condition signals.

Device 201 further includes a processor 205, which is configured to determine that a motor vehicle must be assisted by remote control.

Processor 205 is further configured to check if the at least one safety condition is satisfied.

Processor 205 is further configured to generate the remote control signals.

Device 201 further includes an output 207, which is configured to output the remote control signals generated.

According to one specific embodiment of the present invention, device 201 includes a remote control device, which is configured to control the motor vehicle remotely on the basis of the remote control signals outputted.

In general, signals, which are received, are received with the aid of input 203. Thus, input 203 is configured, in particular, to receive the corresponding signals.

In general, signals, which are outputted, are outputted with the aid of output 207. Thus, output 207 is configured, in particular, to output the corresponding signals.

According to one specific embodiment of the present invention, a plurality of processors are provided in place of the one processor 205.

According to one specific embodiment of the present invention, processor 205 is configured to execute the generating and checking steps described above and/or in the following.

In one specific embodiment of the present invention, one or more method steps up to the steps of generating and outputting the remote control signals are executed inside the motor vehicle, and/or one or more method steps are executed outside of the motor vehicle, in particular, in an infrastructure, preferably, in a cloud infrastructure.

Device 201 is, for example, part of an infrastructure, in particular, cloud infrastructure, or part of the motor vehicle.

According to one specific embodiment of the present invention, for redundant execution of the corresponding method steps, a plurality of devices 201 may be provided, so that, for example, both the motor vehicle and the infrastructure, in particular, the cloud infrastructure, include a device 201.

FIG. 3 shows a machine-readable storage medium 301 in accordance with an example embodiment of the present invention.

A computer program 303 is stored in machine-readable storage medium 301; the computer program including commands, which, in response to execution of computer program 303 by a computer, causes it to implement a method according to the first aspect.

According to one specific embodiment of the present invention, an infrastructure or an infrastructure system is provided, which includes, for example, the device according to the second aspect.

According to one specific embodiment of the present invention, a plurality of surround sensors are positioned within the infrastructure so as to be spatially distributed.

In the spirit of the description herein, a surround sensor is, for example, one of the following surround sensors: radar sensor, lidar sensor, video sensor, ultrasonic sensor, magnetic field sensor, and infrared sensor.

The surround sensors each monitor their surrounding area and supply surround sensor data corresponding to the respective, monitored surrounding area. The surrounding-area signals include, for example, the surround sensor data or are based on the surround sensor data.

In one specific embodiment of the present invention, it is determined or ascertained that a fault and/or a situation is present, which the motor vehicle may no longer solve and/or resolve itself, which means that the motor vehicle must be assisted remotely, in order, for example, to eliminate or compensate for the fault and/or to resolve the situation.

For example, the surrounding-area signals are processed, in order to detect such a situation and/or such a fault. In response to detection, it is then determined accordingly, that the motor vehicle must be assisted by remote control.

For example, the motor vehicle transmits the information item, that it requires assistance via remote control. Accordingly, the step of receiving such an information item is provided, for example.

For example, the status of the motor vehicle is ascertained, in particular, continuously, for example, with the aid of the device according to the second aspect.

For example, a communication link is set up between the motor vehicle and the device, that is, a remote control system, including the device according to the second aspect and the remote control device.

For example, the situation, in which the motor vehicle finds itself, and/or the motor vehicle (in particular, including a position of the motor vehicle) are analyzed by the device, that is, the remote control system.

The analyzing is carried out, for example, automatically.

In one specific embodiment of the present invention, the analysis is carried out and/or supported by a user and/or human personnel.

In one specific embodiment of the present invention, a traffic event in the surroundings of the motor vehicle is analyzed, in particular, with the aid of the device and/or the system, and/or with the aid of the user, in particular, supported by the user.

The analysis of the traffic event is carried out, for example, on the basis of the surrounding-area signals.

The surrounding-area signals include, for example, surround sensor data of the surround sensors, which are positioned within the infrastructure so as to be spatially distributed.

The surrounding-area signals include, for example, surround sensor data of one or more surround sensors of the motor vehicle.

The surrounding-area signals include, for example, surround sensor data of one or more surround sensors of a traffic user in the surroundings of the motor vehicle. A road user is, for example, another motor vehicle. The corresponding surrounding-area sensor data are received, for example, with the aid of V2X communication (“V” stands for vehicle, that is, a motor vehicle; “X” is a wildcard for “V” (vehicle) or “I” (infrastructure); “2” stands for “to”).

In one specific embodiment of the present invention, a solution for the fault and/or the situation is ascertained, in particular, with the aid of the device and/or the system, and/or with the aid of the user, in particular, supported by the user.

The solution includes, for example, a travel route, a setpoint speed, an intended destination.

According to one specific embodiment of the present invention, the remote control signals are generated and outputted on the basis of the solution.

During the remote control of the motor vehicle on the basis of the outputted remote control signals, the preceding steps of analyzing the traffic event, ascertaining a solution and generating and outputting appropriate remote control signals are repeated, in particular, until the situation has beed resolved and/or the fault has been eliminated.

According to one specific embodiment of the present invention, in response to the detection of a hazard, at least one of the following actions are triggered and/or initiated or controlled:

The motor vehicle is stopped by remote control.

Road users, preferably, other motor vehicles and/or pedestrians and/or cyclists, in the surroundings of the motor vehicle, are informed about the hazard, for example, with the aid of one or more V2I communication systems and/or with the aid of external information systems, in particular, electronic signs and/or audio systems. Therefore, this means that such V2I communication systems and/or information systems are controlled, such that they output signals representative of the information about the hazard, in particular, optical signals and/or acoustic signals.

In one specific embodiment of the present invention, traffic system control signals for controlling at least one traffic system are generated and outputted on the basis of the remote control signals.

The execution of the method steps is documented, for example, in a comprehensible manner safe from falsification, for example, in a blockchain.

According to one specific embodiment of the present invention, the individual method steps are carried out automatically, in particular, with the aid of the device and/or the system, that is, in particular, without assistance by a user.

In one specific embodiment of the present invention, if the motor vehicle is still capable of this, it may initiate an emergency stop itself in response to a hazard, that is, in a dangerous situation.

According to one specific embodiment of the present invention, a driver of the motor vehicle is notified that an intervention in the operation of the motor vehicle has taken place or is taking place, that is, that the motor vehicle has been controlled remotely or is being controlled remotely.

Therefore, this means, in particular, that communication signals, which represent a corresponding communication, are generated and outputted. For example, the communication signals are outputted to a human-machine interface of the motor vehicle, which means that with the aid of the human-machine interface, the driver is informed about the intervention or the remote control on the basis of the communication signals.

According to one specific embodiment of the present invention, the intervention or the remote control of the motor vehicle is communicated to an authority, so that, for example, it may initiate further steps.

According to one specific embodiment of the present invention, a condition for the remote control or for the intervention is that the remote control is safe. In the spirit of the description, “safe” means, in particular, “safe” and “secure.” Actually, these two English terms are normally translated into German as “sicker”. Nevertheless, these have a partially different meaning in English.

The term “safe” is directed, in particular, to the topic of accident and accident prevention. Remote control, which is “safe,” causes, in particular, a probability of an accident or a collision to be less than or less than or equal to a predetermined threshold probability value.

The term “secure” is directed, in particular, to the topic of computer protection and/or hacker protection, that is, in particular, how securely is an (a) (computer) infrastructure and/or a communications infrastructure, in particular, a communication path between a motor vehicle and a remote control device for controlling a motor vehicle remotely, protected from unauthorized access and/or from data manipulation by a third party (hacker).

Thus, remote control, which is “secure,” has, in particular, appropriate and sufficient computer protection and/or hacker protection as a basis.

For example, according to one specific embodiment of the present invention, it is tested if the entity made up of a motor vehicle and infrastructure involved in the method according to the first aspect, including communication between the infrastructure and the motor vehicle, is currently secure for the plan, “intervention in the motor vehicle for critical actions,” described here. Therefore, this means, in particular, that the motor vehicle and/or a local and/or a global infrastructure and/or communication are appropriately tested. In particular, the remote control signals are generated on the basis of a result of the testing.

Thus, this means, in particular, that the components, which are used during the execution of the method according to the first aspect, are tested for safety, that is, as to whether these satisfy specific safety conditions, before the intervention in the vehicle operation is carried out, that is, before the motor vehicle is controlled remotely.

Important or dependent criteria include, for example, one or more of the safety conditions described above.

According to one specific embodiment of the present invention, first of all, the overall system (motor vehicle, infrastructure, communication path, cloud, . . . ) is tested with regard to the safety condition.

According to one specific embodiment of the present invention, the individual parts are also tested with regard to satisfying the safety condition. This, in particular, prior to controlling the motor vehicle remotely.

In this context, in one specific embodiment of the present invention, the testing step(s) are executed inside the motor vehicle and/or outside the motor vehicle, in particular, in an infrastructure.

According to one specific embodiment of the present invention, the checking step(s) are tested subsequently, that is, at a later time, for example, at regular intervals. For example, the testing step(s) are tested subsequently at a predetermined frequency, for example, every 100 ms.

For example, according to one specific embodiment of the present invention, this testing, that is, the test as to whether the at least one safety condition is satisfied, is carried out prior to and/or after and/or during one or more predetermined method steps.

According to one specific embodiment of the present invention, the testing is carried out or executed in response to problems.

What is claimed is:

1. A method for controlling a motor vehicle remotely, including the following steps:
determining that a motor vehicle must be assisted by remote control;
receiving safety condition signals, which represent at least one safety condition that must be satisfied, so that the motor vehicle may be controlled remotely;
checking whether the at least one safety condition is satisfied;
generating remote control signals for controlling a lateral and/or longitudinal guidance of the motor vehicle remotely, based on a result of the check as to whether the at least one safety condition is satisfied, to assist the motor vehicle by remote control; and
outputting the generated remote control signals.

2. The method as recited in claim 1, wherein the at least one safety condition is, in each instance, an element selected from the following safety conditions:
(i) presence of a predetermined safety integrity level or automotive safety integrity level of at least the motor vehicle and an infrastructure, including a communication path and/or communications components, for controlling a motor vehicle remotely;
(ii) presence of a maximum latency time of a communication between the motor vehicle and a remote control device for controlling the motor vehicle remotely based on the remote control signals;
(iii) presence of a predetermined computer protection level of a device for executing the method steps;
(iv) presence of predetermined components and/or algorithms and/or communication options, which are used for executing the method steps;
(v) presence of redundancy and/or diversity in predetermined components and/or algorithms and/or communication options, which are used for executing the method steps;
(vi) presence of predetermined availability information, which indicates an availability of predetermined components and/or algorithms and/or communication options;
(vii) presence of predetermined quality criteria of the predetermined components and/or algorithms and/or communication options;
(viii) presence of a plan, which includes measures for reducing faults and/or measures in response to failures of predetermined components and/or algorithms and/or communication options and/or measures for incorrect analyses and/or measures in response to incorrect interpretations;
(ix) presence of one or more fallback scenarios;
(x) presence of a predetermined function;
(xi) presence of a predetermined traffic situation;
(xii) presence of predetermined weather,
(xiii) maximum possible time for a specific performance or execution of one method step of the method steps or a plurality of the method steps;
(xiv) presence of a test result, that elements or functions, which are used for executing the method, are presently functioning correctly.

3. The method as recited in claim 1, wherein the remote control signals are generated only when the at least one safety condition is satisfied.

4. The method as recited in claim 1, wherein the check as to whether the at least one safety condition is satisfied, is carried out prior to and/or after and/or during one or more predetermined method steps.

5. The method as recited in claim 1, wherein after the outputting of the remote control signals, remote control of the motor vehicle is tested based on the output remote control signals to detect a fault, and in response to the detection of the fault, the remote control is interrupted, or emergency remote control signals for controlling the motor vehicle remotely in an emergency are generated and output.

6. The method as recited in claim 1, wherein: (i) one or more of the method steps up to the steps of generating and outputting the remote control signals, are executed inside the motor vehicle, and/or (ii) one or more of the method steps are executed outside of the motor vehicle in an infrastructure.

7. The method as recited in claim 6, wherein the infrastructure is a cloud infrastructure.

8. The method as recited in claim 1, wherein one or more of the method steps are documented in a blockchain.

9. The method as recited in claim 1, wherein it is tested if an entity made up of the motor vehicle and infrastructure involved in the method, including communication between the infrastructure and the motor vehicle, is safe, so that the motor vehicle and/or a local infrastructure and/or a global infrastructure and/or communication between the motor vehicle and the infrastructure are tested.

10. The method as recited in claim 1, wherein traffic system control signals for controlling at least one traffic system are generated and output based on the remote control signals.

11. The method as recited in claim 1, wherein status signals are received, which represent a status of the motor vehicle, and as a function of the status, it is determined that the motor vehicle must be assisted by remote control.

12. The method as recited in claim 1, wherein situation signals are received, which represent a situation in which the motor vehicle finds itself, based on the situation signals, it is determined whether the motor vehicle is in an emergency situation, which the motor vehicle is unable to resolve at least in a semiautomated manner, and it is determined that the motor vehicle must be assisted by remote control when the motor vehicle is in an emergency situation, which the motor vehicle is unable to resolve at least in a semiautomated manner.

13. A device for controlling a motor vehicle remotely, the device configured to:
determine that a motor vehicle must be assisted by remote control;
receive safety condition signals, which represent at least one safety condition that must be satisfied, so that the motor vehicle may be controlled remotely;
check whether the at least one safety condition is satisfied;
generate remote control signals for controlling a lateral and/or longitudinal guidance of the motor vehicle remotely, based on a result of the check as to whether the at least one safety condition is satisfied, to assist the motor vehicle by remote control; and
output the generated remote control signals.

14. A non-transitory machine-readable storage medium on which is stored a computer program for controlling a motor vehicle remotely, the computer program, when executed by a computer, causing the computer to perform the following steps:
determining that a motor vehicle must be assisted by remote control;
receiving safety condition signals, which represent at least one safety condition that must be satisfied, so that the motor vehicle may be controlled remotely;
checking whether the at least one safety condition is satisfied;
generating remote control signals for controlling a lateral and/or longitudinal guidance of the motor vehicle remotely, based on a result of the check as to whether the at least one safety condition is satisfied, to assist the motor vehicle by remote control; and
outputting the generated remote control signals.
